(19) United States
(12) Patent Application Publication
(10) Pub. No.: US 2023/0104269 A1
(43) Pub. Date: Apr. 6, 2023

(54) REDUCED-CAPABILITY-SPECIFIC INITIAL BANDWIDTH PARTS

(71) Applicant: QUALCOMM Incorporated, San Diego, CA (US)

(72) Inventors: Linhai HE, San Diego, CA (US); Jing LEI, San Diego, CA (US); Muhammad Nazmul ISLAM, Littleton, MA (US)

(21) Appl. No.: 17/660,053

(22) Filed: Apr. 21, 2022

Related U.S. Application Data
(60) Provisional application No. 63/262,007, filed on Oct. 1, 2021.

(51) Int. Cl. H04W 72/04; H04W 72/00; H04W 74/08

(52) U.S. Cl. CPC H04W 72/048; H04W 72/044; H04W 72/005; H04W 74/0833

(57) ABSTRACT

Various aspects of the present disclosure generally relate to wireless communication. In some aspects, a user equipment (UE) may monitor a control channel configured within a reduced capability (RedCap)-specific initial downlink bandwidth part (BWP), wherein the UE is a RedCap UE operating in idle mode or inactive mode. The UE may receive at least one communication via the control channel. Numerous other aspects are described.

### CROSS-REFERENCE TO RELATED APPLICATION

This Patent Application claims priority to U.S. Provisional Patent Application No. 63/262,007, filed on Oct. 1, 2021, entitled “REDUCED-CAPABILITY-SPECIFIC INITIAL BANDWIDTH PARTS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for reduced-capability-specific initial bandwidth parts.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include monitoring a control channel configured within a reduced capability (RedCap)-specific initial downlink bandwidth part (BWP), wherein the UE is a RedCap UE operating in idle mode or inactive mode. The method may include receiving at least one communication via the control channel.

Some aspects described herein relate to a method of wireless communication performed by a network node. The method may include transmitting a first communication on a first control channel that corresponds to a non-RedCap-specific initial downlink BWP. The method may include transmitting a second communication on a second control channel that corresponds to a RedCap-specific initial downlink BWP.

Some aspects described herein relate to a UE for wireless communication. The UE may include a memory and one or more processors coupled to the memory. The one or more processors may be configured to monitor a control channel configured within a RedCap-specific initial downlink BWP, wherein the UE is a RedCap UE operating in idle mode or inactive mode. The one or more processors may be configured to receive at least one communication via the control channel.

Some aspects described herein relate to a network node for wireless communication. The network node may include a memory and one or more processors coupled to the memory. The one or more processors may be configured to transmit a first communication on a first control channel configured within a non-RedCap-specific initial downlink BWP. The one or more processors may be configured to transmit a second communication on a second control channel configured within a RedCap-specific initial downlink BWP.

Some aspects described herein relate to a non-transitory computer-readable medium that stores a set of instructions for wireless communication by a UE. The set of instructions, when executed by one or more processors of the UE, may cause the UE to monitor a control channel configured within a RedCap-specific initial downlink BWP, wherein the UE is a RedCap UE operating in idle mode or inactive mode. The set of instructions, when executed by one or more processors of the UE, may cause the UE to receive at least one communication via the control channel.

Some aspects described herein relate to a non-transitory computer-readable medium that stores a set of instructions for wireless communication by a network node. The set of instructions, when executed by one or more processors of the network node, may cause the network node to transmit a first communication on a first control channel configured within a non-RedCap-specific initial downlink BWP. The set of instructions, when executed by one or more processors of the network node, may cause the network node to transmit a second communication on a second control channel configured within a RedCap-specific initial downlink BWP.

Some aspects described herein relate to an apparatus for wireless communication. The apparatus may include means for monitoring a control channel configured within a RedCap-specific initial downlink BWP, wherein the UE is a RedCap UE operating in idle mode or inactive mode. The apparatus may include means for receiving at least one communication via the control channel.

Some aspects described herein relate to an apparatus for wireless communication. The apparatus may include means for transmitting a first communication on a first control channel configured within a non-RedCap-specific initial downlink BWP. The apparatus may include means for transmitting a second communication on a second control channel configured within a RedCap-specific initial downlink BWP.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of an open radio access network, in accordance with the present disclosure.

FIG. 4 is a diagram illustrating an example associated with reduced-capability (RedCap)-specific initial downlink bandwidth parts (BWPs), in accordance with the present disclosure.

FIGS. 5 and 6 are diagrams illustrating example processes associated with RedCap-specific initial downlink BWPs, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

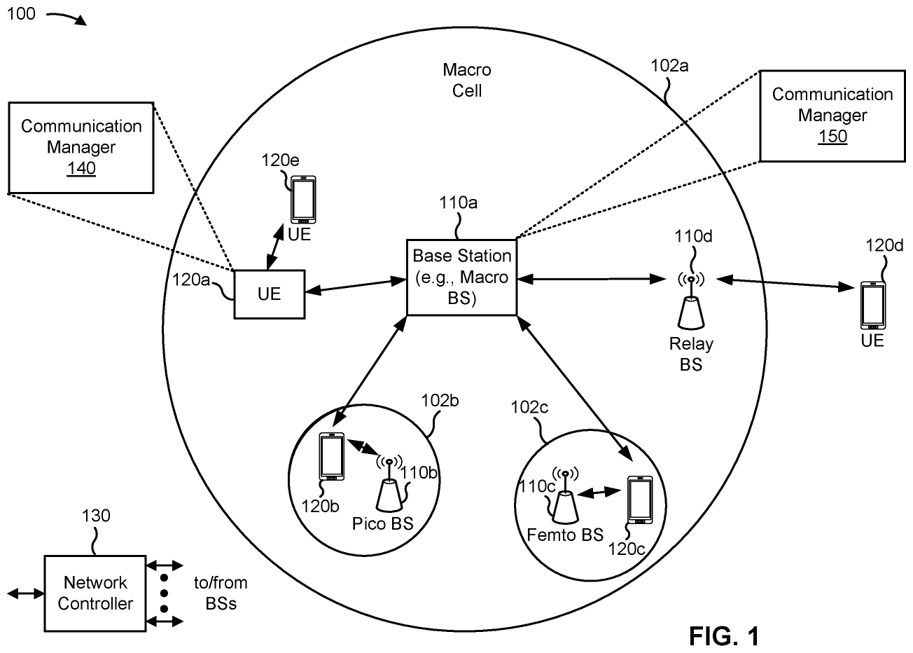

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which also may be referred to as a “node” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, the UE 120 may include a communication manager 140. As described in more detail elsewhere herein, the communication manager 140 may monitor a control channel configured within a reduced capability (RedCap)-specific initial downlink bandwidth part (BWP), wherein the UE is a RedCap UE operating in idle mode or inactive mode; and receive at least one communication via the control channel. Additionally, or alternatively, the communication manager 140 may perform one or more other operations described herein.

In some aspects, a network node (e.g., the base station 110) may include a communication manager 150. As described in more detail elsewhere herein, the communication manager 150 may transmit a first communication on a first control channel configured within a non-RedCap-specific initial downlink BWP; and transmit a second communication on a second control channel configured within a RedCap-specific initial downlink BWP. Additionally, or alternatively, the communication manager 150 may perform one or more other operations described herein.

As indicated above, FIG. 1 is provided as an example. Other examples may differ from what is described with regard to FIG. 1.

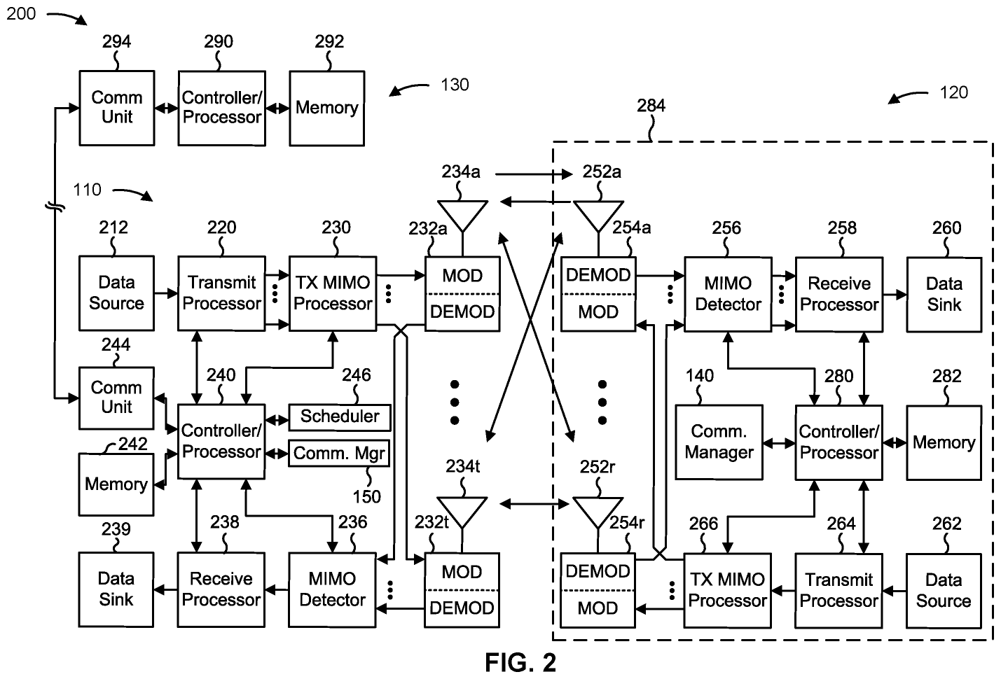

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

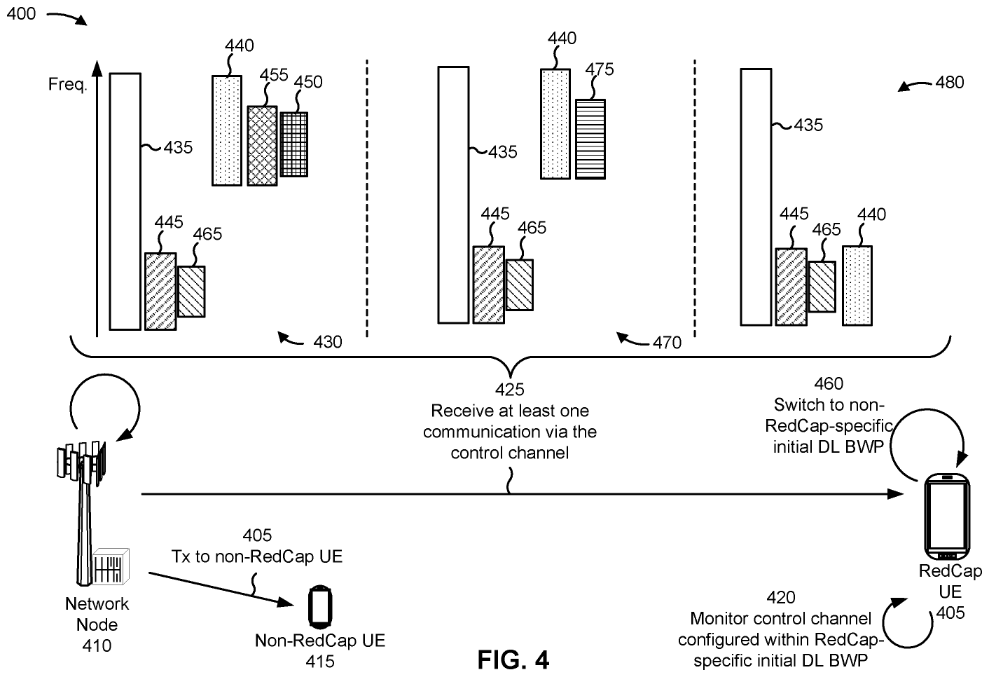

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

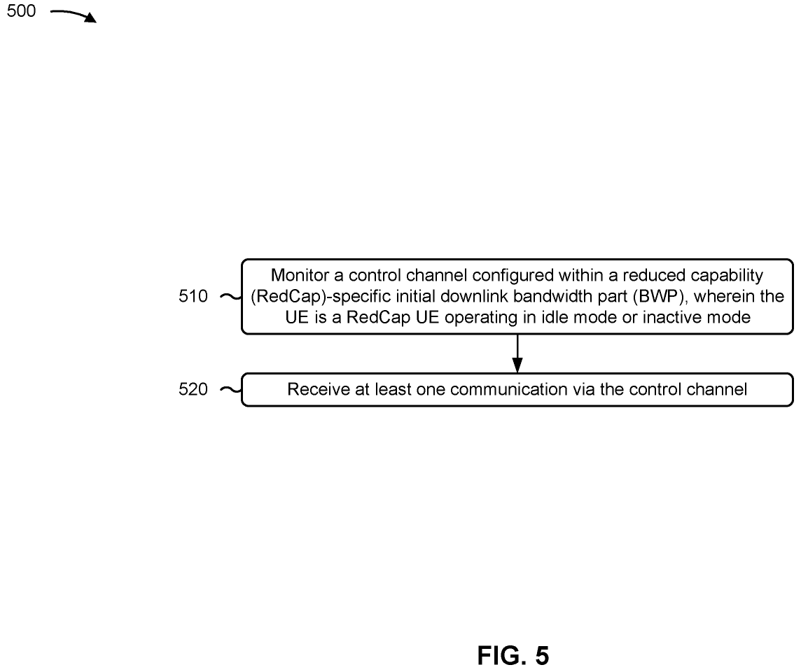

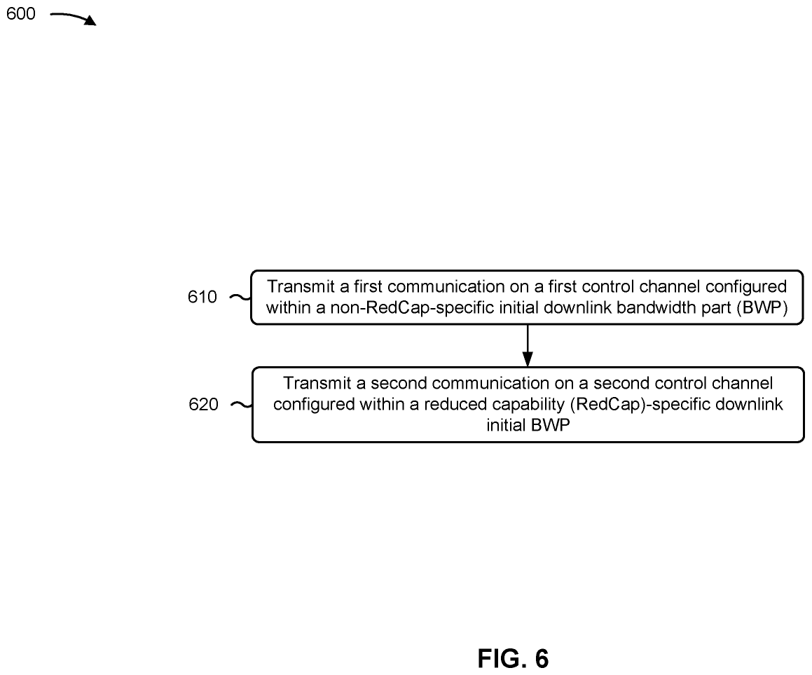

The controller/processor 240 of the base station 110, the controller/processor 280 of the UE 120, and/or any other component(s) of FIG. 2 may perform one or more techniques associated with RedCap-specific initial downlink BWPs, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for monitoring a control channel configured within a RedCap-specific initial downlink BWP, wherein the UE is a RedCap UE operating in idle mode or inactive mode; and/or means for receiving at least one communication via the control channel. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting a first communication on a first control channel configured within a non-RedCap-specific initial downlink BWP; and/or means for transmitting a second communication on a second control channel configured within a RedCap-specific initial downlink BWP. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

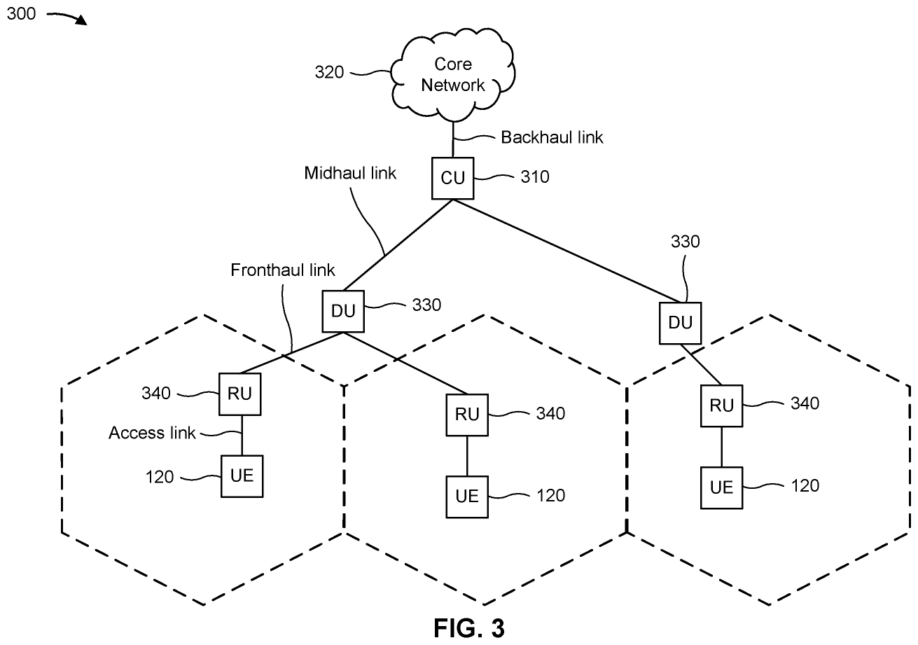

FIG. 3 is a diagram illustrating an example 300 of an O-RAN architecture, in accordance with the present disclosure. As shown in FIG. 3, the O-RAN architecture may include a control unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (0-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

In some aspects, a network node may serve different UEs of different categories and/or different UEs that support different capabilities. For example, the network node may serve a first category of UEs that have a less advanced capability (e.g., a lower capability and/or a reduced capability) and a second category of UEs that have a more advanced capability (e.g., a higher capability). A UE of the first category may have a reduced feature set compared to UEs of the second category and may be referred to as a reduced-capability (RedCap) UE (which may be interchangeably referred to as a reduced-capacity UE, also having the acronym “RedCap”), a low tier UE, and/or an NR-Lite UE, among other examples. A UE of the second category may be an ultra-reliable low-latency communication (URLLC) device and/or an enhanced mobile broadband (eMBB) device and may have an advanced feature set compared to RedCap UEs. RedCap UEs may include wearable devices, IoT devices, sensors, cameras, and/or the like that are associated with a limited bandwidth, power capacity, and/or transmission range, among other examples. A UE of the second category may be referred to as a baseline UE, a high tier UE, an NR UE, and/or a premium UE, among other examples. In some aspects, a RedCap UE may have capabilities that satisfy requirements of a first wireless communication standard but not a second wireless communication standard, while a UE of the second category may have capabilities that satisfy requirements of the second wireless communication standard (and also the first wireless communication standard, in some cases).

For example, a RedCap UE of the first category may support a lower maximum MCS than a UE of the second category (e.g., quadrature phase shift keying (QPSK) or the like as compared to 256-quadrature amplitude modulation (QAM) or the like), may support a lower maximum transmit power than a UE of the second category, may have a less advanced beamforming capability than a UE of the second category (e.g., may not be capable of forming as many beams as a UE of the second category), may require a longer processing time than a UE of the second category, may include less hardware than a UE of the second category (e.g., fewer antennas, fewer transmit antennas, and/or fewer receive antennas), and/or may not be capable of communicating on as wide of a maximum BWP as a UE of the second category, among other examples. In some instances, the bandwidth, power capacity, computational capability, and/or transmission range of a RedCap UE may be limited or reduced relative to an eMBB UE (which may be referred to herein, interchangeably, as a “non-RedCap eMBB UE”). Similarly, a BWP, control channel, search space set, and/or bandwidth or other feature that is specific to, or otherwise dedicated for use with or by, a RedCap UE may be referred to as “RedCap-specific.” A BWP, control channel, search space set, and/or bandwidth or other feature that is specific to, otherwise dedicated for use with or by, a non-RedCap UE, and/or is not RedCap-specific, may be referred to as “Non-RedCap-specific.”

In some cases, idle mode and/or inactive mode procedures (e.g., initial access, paging, synchronization, and/or system information broadcasting, among other examples) can be performed by a network node and a UE in an initial downlink BWP. In some cases, because a RedCap UE may not have the capability to receive transmissions across the entire initial downlink BWP, the UE may miss communications, which may affect the ability of the UE to perform idle mode and/or inactive mode procedures, thereby negatively impacting network and/or device performance.

Aspects of techniques and apparatuses described herein facilitate providing for idle mode and/or inactive mode procedures for RedCap UEs use RedCap-specific initial downlink BWPs. In some aspects, a RedCap UE may monitor a control channel configured within a RedCap-specific initial downlink BWP. The RedCap UE may be operating in idle mode or inactive mode and may receive at least one communication via the control channel. As a result, aspects may facilitate enabling RedCap UEs to perform idle mode and/or inactive mode procedures using a RedCap-specific initial downlink BWP. Accordingly, some aspects of the disclosure may facilitate reducing the incidents of missed communications, thereby having a positive impact on network and/or device performance.

FIG. 4 is a diagram illustrating an example 400 associated with RedCap-specific initial downlink BWPs, in accordance with the present disclosure. As shown in FIG. 4, a RedCap UE 405 and a network node 410 may communicate with one another. The network node 410 may communicate with a non-RedCap UE 415 as well. In some aspects, any number of RedCap UEs and/or non-RedCap UEs may communicate with the network node.

As shown by reference number 420, the RedCap UE 405 may monitor a control channel corresponding to a RedCap-specific initial downlink BWP. The RedCap UE 405 may be operating in idle mode or inactive mode. As shown by reference number 425, the RedCap UE 405 may receive at least one communication via the control channel. As shown by reference number 430, which depicts frequency resources associated with a non-RedCap-specific initial downlink BWP 435 (e.g., a default initial downlink BWP) and a RedCap-specific initial downlink BWP 440, the RedCap-specific initial downlink BWP 440 may have a narrower bandwidth than the non-RedCap-specific initial downlink BWP. In some aspects, the RedCap-specific initial downlink BWP 440 may be, or include, a RedCap specific initial downlink BWP and/or a RedCap-specific initial uplink BWP. Similarly, the non-RedCap-specific initial downlink BWP 435 may be, or include, a non-RedCap-specific initial downlink BWP and/or a non-RedCap-specific initial uplink BWP.

In some aspects, the control channel may include a paging control channel (PCCH). The RedCap UE 405 may monitor the PCCH periodically. The RedCap UE 405 may monitor the control channel (e.g., the PCCH) by monitoring a common search space (CSS) configured within the RedCap-specific initial downlink BWP 440. The PCCH may be provided over the CSS, which may correspond to a control resource set (CORESET) #0 445. In some aspects, as shown, the network node 410 may transmit, and the RedCap UE 405 may receive, a non-cell-defining synchronization signal block (SSB) 450 corresponding to the RedCap-specific initial downlink BWP. In some aspects, the RedCap-specific initial downlink BWP also may include one or more CSSs 455 of Type-0, Type-1, Type-2, and/or Type-3.

In some aspects, a broadcast control channel (BCCH) may be configured within the non-RedCap-specific initial downlink BWP 435 and/or the RedCap-specific initial downlink BWP 440. For example, in some aspects, the BCCH may not be configured in the RedCap-specific initial downlink BWP 440. In those cases, as shown by reference number 460, the RedCap UE 405 may switch to the non-RedCap-specific initial downlink BWP 435. For example, the RedCap UE 405 may switch to the non-RedCap-specific initial downlink BWP 435 to receive system information (SI). In some aspects, whenever there is an SI update, or the RedCap UE 405 requests on-demand SI (ODSI), the RedCap UE 405 may switch its active BWP to the non-RedCap-specific initial downlink BWP 435 to obtain SI. The SI may be transmitted using a system information block (SIB) and/or an SSB. A SIB may include an specified first SIB (e.g., a SIB1) and/or a master information block (MIB), among other examples. In some aspects, the bandwidth of the BCCH may be less than a maximum bandwidth that the RedCap UE 405 is capable of receiving.

In some aspects, the network node 410 may transmit, and the RedCap UE 405 may receive, the MIB and/or SSB over a BCCH configured within the RedCap-specific initial downlink BWP 440. For example, the network node 410 may use a Type-0 CSS 455 to transmit the MIB and/or SSB. In some aspects, the network node 410 may duplicate the BCCH of the non-RedCap-Specific initial downlink BWP 435 in the RedCap-specific initial downlink BWP 440. For example, in some aspects, the network node 410 may periodically transmit a MIB and an SIB1 in the RedCap-specific initial downlink BWP 440, as it does in the non-RedCap-Specific initial downlink BWP 435. In some aspects, whenever ODSI is requested, regardless of whether this request is sent by a non-RedCap UE 415 in a non-RedCap-Specific initial downlink BWP 435 or by the RedCap UE in a RedCap-specific downlink BWP 440, and/or if there is an SI update, the network node 410 may transmit the ODSI over a BCCH in both the non-RedCap-Specific initial downlink BWP 435 and the RedCap-specific downlink BWP 440.

In some aspects, the network node 410 may separate BCCH operations in the non-RedCap-Specific initial downlink BWP 435 from BCCH operations in the RedCap-specific initial downlink BWP. For example, in some aspects, the network node 410 may transmit a MIB and a SIB (e.g., SIB1) periodically in both the non-RedCap-Specific initial downlink BWP 435 and the RedCap-specific initial downlink BWP 440. In the non-RedCap-Specific initial downlink BWP 435, the network node 410 and non-RedCap UE 415 may apply legacy procedures for SI delivery, including ODSI. If a change to SI is not applicable to any RedCap UEs 405, the network node 410 may not transmit SIBs that indicate the changed SI in the RedCap-specific initial downlink BWP 440, but may transmit the SIBs only in the non-RedCap-Specific initial downlink BWP 435. Similarly, if the non-RedCap UE 415 transmits a request for ODSI, the network node 410 may transmit a responding SIB in the non-RedCap-Specific initial downlink BWP 435, but not in the RedCap-specific initial downlink BWP 440.

In some aspects, when there is an SI update and the update is only relevant to RedCap UEs 405, the network node 410 may send a RedCap-specific short message in the RedCap-specific initial downlink BWP 440 to notify only the RedCap UEs 405 about the change. RedCap UEs 405 may also acquire new SI via the RedCap-specific initial downlink BWP 440. For example, the network node 410 may transmit, and the RedCap UE 405 may receive, a RedCap-specific short message that indicates a RedCap-specific SI update.

In some aspects, the RedCap UE 405 may request ODSI via a random access channel (RACH) procedure in the RedCap-specific initial downlink BWP 440. The RedCap UE 405 may transmit, and the network node 410 may receive, via a RACH procedure corresponding to the RedCap-specific initial downlink BWP, a request for ODSI. For example, in some aspects, the RedCap UE 405 may transmit the request via a PRACH transmission. The network node 410 may respond to the request by transmitting ODSI in the RedCap-specific initial downlink BWP 440, but not in the non-RedCap-Specific initial downlink BWP 435. In some aspects, the network node 410 may transmit, and the RedCap UE 405 may receive, an SIB corresponding to the RedCap-specific initial downlink BWP 440, where the SIB is associated with one or more RedCap-specific transmission parameters. The RedCap-specific transmission parameters may be different than transmission parameters used in the non-RedCap-Specific initial downlink BWP 435 and may be configured to better support the reduced receiving capabilities of the RedCap UEs 405. For example, the transmission parameters may include transmission power, bandwidth, and/or MCS, among other examples.

In some aspects, the network node 410 may transmit SI updates to the RedCap UE 405 using dedicated signaling (UE-specific signaling). When there is an SI update and the update is relevant to RedCap UEs 405, the network node 410 may transmit the updated SIB(s) (e.g., including MIB and/or SIB1) to RRC connected RedCap UEs 405 via their respective physical downlink shared channels (PDSCHs) by dedicated signaling. For example, in some aspects, the RedCap UE 405 may perform, via the RedCap-specific initial downlink BWP 440, an initial access procedure to enter an RRC connected state. The network node 410 may transmit, and the RedCap UE 405 may receive, a UE-specific signal corresponding to a PDSCH associated with the RedCap UE 405. The UE-specific signal may include an updated SIB.

In some aspects, the network node 410 may indicate in an SIB (e.g., an SIB1) in the non-RedCap-Specific initial downlink BWP 435 which mode RedCap UEs 405 should use to obtain SI. For example, the network node 410 may transmit, and the RedCap UE 405 may receive, an SIB corresponding to the non-RedCap-Specific initial downlink BWP 435. The SIB may indicate a mode that the UE is to use to obtain SI.

In some aspects, radio resource management (RRM) measurements performed by the RedCap UE 405 associated with serving cells and/or neighbor cells may be based on SSBs transmitted in the RedCap-specific initial downlink BWP 440, and not SSBs transmitted in the non-RedCap-Specific initial downlink BWP 435. For example, in some aspects, the network node 410 may transmit, and the RedCap UE 405 may receive, at least one SSB corresponding to the RedCap-specific initial downlink BWP 440. The RedCap UE 405 may obtain one or more RRM measurements based at least in part on the at least one SSB. Cell barring indications and unified access control (UAC) indications may be transmitted in the non-RedCap-Specific initial downlink BWP 435. For example, the RedCap UE 405 may switch to the non-RedCap-Specific initial downlink BWP 435 and may receive, from the network node 410, at least one of a cell barring indication or a UAC indication via the non-RedCap-Specific initial downlink BWP 435.

As shown by reference number 470, in some aspects, the RedCap-specific initial downlink BWP 440 may include only a random access search space (“ra-searchspace”) 475. For example, in some aspects, the RedCap UE 405 may monitor a random access search space 475 configured within the RedCap-specific initial downlink BWP 440, where the RedCap-specific initial downlink BWP 440 contains only one search space — the random access search space 475. As a result, the RedCap UE 405 may still camp in the non-RedCap-Specific initial downlink BWP 435 to perform most of the idle-mode procedures (e.g., except RACH messages subsequent to the PRACH message). For example, the RedCap UE 405 may receive cell barring and UAC indications in an SIB1 transmitted in the non-RedCap-Specific initial downlink BWP 435. The RedCap UE 405 may monitor SI and paging channels in the non-RedCap-Specific initial downlink BWP 435, and/or the RedCap UE 405 may perform RRM measurements on a cell-defining SSB 465 transmitted within the non-RedCap-Specific initial downlink BWP 435.

When the RedCap UE 405 performs a RACH procedure, the RedCap UE 405 may first switch to the RedCap-specific initial downlink BWP 440. For example, the RedCap UE 405 may transmit RACH messages (e.g., Msg1, MsgA, and/or Msg3) in a RedCap-specific initial downlink BWP and may receive RACH messages (e.g., Msg 2, Msg B, and/or Msg 4) in the random access search space 475 configured in the RedCap-specific initial downlink BWP 440. For example, in some aspects, the RedCap UE 405 may switch from the non-RedCap-Specific initial downlink BWP 435 to the RedCap-specific initial downlink BWP 440 and may perform a RACH procedure corresponding to the RedCap-specific initial downlink BWP 440.

As shown by reference number 480, in some aspects, the RedCap-specific initial downlink BWP 440 may share a CORESET #0 and/or SSBs with the non-RedCap-Specific initial downlink BWP 435. Similarly, the RedCap-specific BWP 440 may share the same PRACH as the non-RedCap-Specific initial downlink BWP 435. In some aspects, for example, the RedCap-specific initial downlink BWP 440 shares a CSS with the non-RedCap-Specific initial downlink BWP 435.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with RedCap-specific initial downlink BWPs.

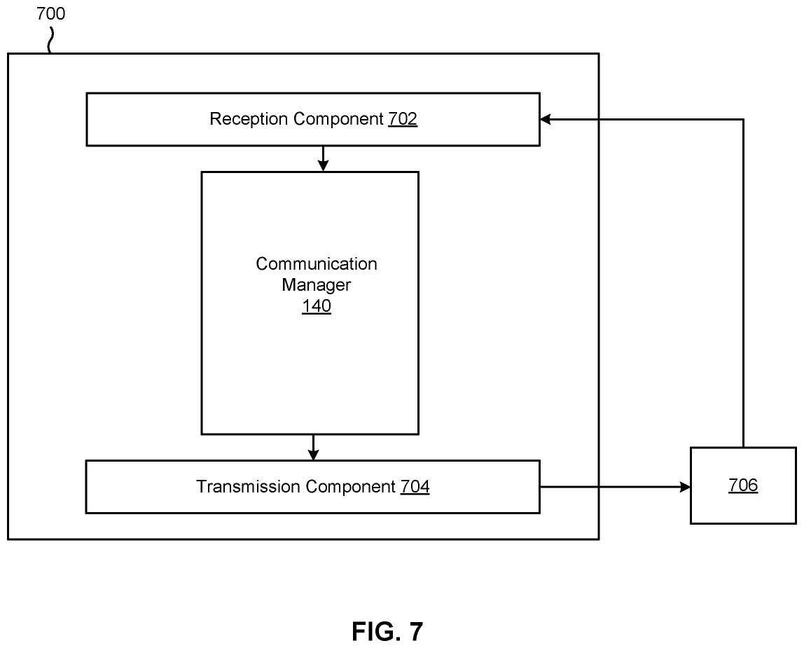

As shown in FIG. 5, in some aspects, process 500 may include monitoring a control channel configured within a RedCap-specific initial downlink BWP, wherein the UE is a RedCap UE operating in idle mode or inactive mode (block 510). For example, the UE (e.g., using communication manager 140 and/or reception component 702, depicted in FIG. 7) may monitor a control channel corresponding to a RedCap-specific initial downlink BWP, wherein the UE is a RedCap UE operating in idle mode or inactive mode, as described above.

As further shown in FIG. 5, in some aspects, process 500 may include receiving at least one communication via the control channel (block 520). For example, the UE (e.g., using communication manager 140 and/or reception component 702, depicted in FIG. 7) may receive at least one communication via the control channel, as described above.

Process 500 may include additional aspects, such as any single aspect or any combination of aspects described below and/or in connection with one or more other processes described elsewhere herein.

In a first aspect, the control channel comprises a PCCH. In a second aspect, alone or in combination with the first aspect, monitoring the control channel comprises monitoring a CSS configured within the RedCap-specific initial downlink BWP. In a third aspect, alone or in combination with one or more of the first and second aspects, process 500 includes receiving a non-cell-defining SSB corresponding to the RedCap-specific initial downlink BWP.

In a fourth aspect, alone or in combination with one or more of the first through second aspects, process 500 includes switching to a non-RedCap-Specific initial downlink BWP and monitoring a BCCH configured within the non-RedCap-Specific initial downlink BWP, wherein the BCCH corresponds to a bandwidth that is less than or equal to a maximum bandwidth capability of the UE. In a fifth aspect, alone or in combination with the fourth aspect, process 500 includes receiving system information via the BCCH.

In a sixth aspect, alone or in combination with one or more of the first through second aspects, the control channel comprises a BCCH configured within the RedCap-specific initial downlink BWP. In a seventh aspect, alone or in combination with the sixth aspect, process 500 includes receiving, via the BCCH, at least one of a master information block or a system information block.

In an eighth aspect, alone or in combination with one or more of the first through seventh aspects, process 500 includes receiving a RedCap-specific short message that indicates a RedCap-specific system information update. In a ninth aspect, alone or in combination with one or more of the first through eighth aspects, process 500 includes transmitting, via a random access channel procedure corresponding to the RedCap-specific initial downlink BWP, a request for on-demand system information.

In a tenth aspect, alone or in combination with one or more of the first through ninth aspects, process 500 includes performing, via the RedCap-specific initial downlink BWP, an initial access procedure to enter an RRC connected state and receiving a UE-specific signal corresponding to a PDSCH associated with the UE, wherein the UE-specific signal includes an updated SIB.

In an eleventh aspect, alone or in combination with one or more of the first through tenth aspects, process 500 includes receiving an SIB corresponding to a non-RedCap-Specific initial downlink BWP, wherein the SIB indicates a mode that the UE is to use to obtain system information. In a twelfth aspect, alone or in combination with one or more of the first through eleventh aspects, process 500 includes receiving an SIB corresponding to the RedCap-specific initial downlink BWP, wherein the SIB is associated with one or more RedCap-specific transmission parameters.

In a thirteenth aspect, alone or in combination with one or more of the first through twelfth aspects, process 500 includes receiving at least one SSB corresponding to the RedCap-specific initial downlink BWP and obtaining one or more RRM measurements based at least in part on the at least one SSB. In a fourteenth aspect, alone or in combination with one or more of the first through thirteenth aspects, process 500 includes switching to a non-RedCap-Specific initial downlink BWP, and receiving at least one of a cell barring indication or a unified access control indication via the non-RedCap-Specific initial downlink BWP.

In a fifteenth aspect, alone or in combination with one or more of the first through fourteenth aspects, monitoring the control channel comprises monitoring a random access search space configured within the RedCap-specific initial downlink BWP. In a sixteenth aspect, alone or in combination with the fifteenth aspect, the RedCap-specific initial downlink BWP contains only one search space, the one search space comprising the random access search space. In a seventeenth aspect, alone or in combination with one or more of the fifteenth through sixteenth aspects, process 500 includes switching from a non-RedCap-Specific initial downlink BWP to the RedCap-specific initial downlink BWP, and performing a RACH procedure corresponding to the RedCap-specific initial downlink BWP.

In an eighteenth aspect, alone or in combination with one or more of the first through seventeenth aspects, the RedCap-specific initial downlink BWP shares a common search space with a non-RedCap-Specific initial downlink BWP. In a nineteenth aspect, alone or in combination with one or more of the first through eighteenth aspects, the RedCap-specific initial downlink BWP shares a synchronization signal block with a non-RedCap-Specific initial downlink BWP. In a twentieth aspect, alone or in combination with one or more of the first through nineteenth aspects, the RedCap-specific initial downlink BWP shares a physical random access channel with a non-RedCap-Specific initial downlink BWP.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a network node, in accordance with the present disclosure. Example process 600 is an example where the network node (e.g., network node 410) performs operations associated with RedCap-specific initial downlink BWPs.

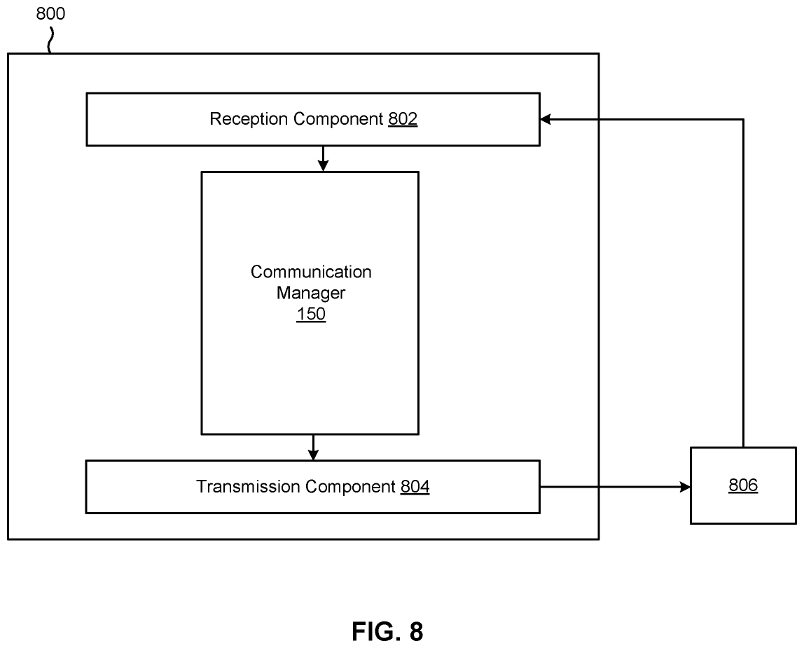

As shown in FIG. 6, in some aspects, process 600 may include transmitting a first communication on a first control channel configured within a non-RedCap-Specific initial downlink BWP (block 610). For example, the network node (e.g., using communication manager 150 and/or transmission component 804, depicted in FIG. 8) may transmit a first communication on a first control channel configured within a default initial downlink BWP, as described above.

As further shown in FIG. 6, in some aspects, process 600 may include transmitting a second communication on a second control channel configured within a RedCap-specific initial downlink BWP (block 620). For example, the network node (e.g., using communication manager 150 and/or transmission component 804, depicted in FIG. 8) may transmit a second communication on a second control channel configured within a RedCap-specific initial downlink BWP, as described above.

Process 600 may include additional aspects, such as any single aspect or any combination of aspects described below and/or in connection with one or more other processes described elsewhere herein.

In a first aspect, the second control channel comprises a PCCH. In a second aspect, alone or in combination with the first aspect, the second control channel includes a CSS. In a third aspect, alone or in combination with one or more of the first and second aspects, the second communication comprises an SSB. In a fourth aspect, alone or in combination with one or more of the first through third aspects, the second communication comprises an SSB (e.g., a cell-defining SSB or a non-cell-defining SSB).

In a fifth aspect, alone or in combination with one or more of the first through fourth aspects, the first control channel comprises a BCCH, wherein the BCCH corresponds to a bandwidth that is less than or equal to a maximum bandwidth capability of a RedCap UE. In a sixth aspect, alone or in combination with the fifth aspect, the first communication comprises SI. In a seventh aspect, alone or in combination with one or more of the first through sixth aspects, the first control channel comprises a first instance of a BCCH, and the second control channel comprises a second instance of the BCCH. In an eighth aspect, alone or in combination with the seventh aspect, the first communication comprises a first instance of at least one of a MIB or SIB, and the second communication comprises a second instance of the at least one of the MIB or the SIB.

In a ninth aspect, alone or in combination with one or more of the first through sixth aspects, the first control channel comprises a first BCCH, and the second control channel comprises a second BCCH that is different than the first BCCH. In a tenth aspect, alone or in combination with the ninth aspect, process 600 includes determining that a change in SI is not applicable to any RedCap UE, transmitting an SIB on the first control channel, wherein the SIB indicates the change in the system information, and refraining from transmitting an SIB on the second control channel based at least in part on determining that the change in the system information is not applicable to any RedCap UE. In an eleventh aspect, alone or in combination with one or more of the ninth through tenth aspects, process 600 includes receiving, via the non-RedCap-Specific initial downlink BWP, a request for ODSI from a UE, transmitting, via the default initial downlink BWP, an SIB that indicates the ODSI, and refraining from transmitting an SIB indicating the ODSI via the RedCap-specific initial downlink BWP based at least in part on not receiving a request for the ODSI from a RedCap UE.

In a twelfth aspect, alone or in combination with one or more of the first through eleventh aspects, process 600 includes transmitting a RedCap-specific short message that indicates a RedCap-specific SI update. In a thirteenth aspect, alone or in combination with one or more of the first through twelfth aspects, process 600 includes receiving, via a RACH procedure corresponding to the RedCap-specific initial downlink BWP, a request for ODSI from a RedCap UE, transmitting, via the RedCap-specific initial downlink BWP, an SIB that indicates the ODSI, and refraining from transmitting an SIB indicating the ODSI via the non-RedCap-Specific initial downlink BWP based at least in part on not receiving a request for the ODSI from a non-RedCap UE.

In a fourteenth aspect, alone or in combination with one or more of the first through eleventh aspects, process 600 includes performing, via the RedCap-specific initial downlink BWP, an initial access procedure to connect to a UE, and transmitting a UE-specific signal corresponding to a PDSCH associated with the UE, wherein the UE-specific signal includes an updated SIB.

In a fifteenth aspect, alone or in combination with one or more of the first through eleventh aspects, process 600 includes transmitting an SIB corresponding to a non-RedCap-Specific initial downlink BWPc, wherein the SIB indicates a mode that a UE is to use to obtain SI.

In a sixteenth aspect, alone or in combination with one or more of the first through fifteenth aspects, the second communication comprises an SIB associated with one or more RedCap-specific transmission parameters. In a seventeenth aspect, alone or in combination with one or more of the first through sixteenth aspects, transmitting the second communication comprises transmitting the second communication to a RedCap UE, and transmitting the first communication comprises transmitting the first communication to the RedCap UE after the RedCap UE has switched to the non-RedCap-Specific initial downlink BWP, wherein the first communication comprises at least one of a cell barring indication or a UAC indication.

In an eighteenth aspect, alone or in combination with one or more of the first through seventeenth aspects, the second control channel comprises a random access search space. In a nineteenth aspect, alone or in combination with the eighteenth aspect, the RedCap-specific initial downlink BWP contains only one search space, the one search space comprising the random access search space.

In a twentieth aspect, alone or in combination with one or more of the first through nineteenth aspects, the RedCap-specific initial downlink BWP shares a common search space with a non-RedCap-Specific initial downlink BWP. In a twenty-first aspect, alone or in combination with one or more of the first through twentieth aspects, the RedCap-specific initial downlink BWP shares a synchronization signal block with a non-RedCap-Specific initial downlink BWP. In a twenty-second aspect, alone or in combination with one or more of the first through twenty-first aspects, the RedCap-specific initial downlink BWP shares a physical random access channel with a non-RedCap-Specific initial downlink BWP.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a network node, or another wireless communication device) using the reception component 702 and the transmission component 704. As further shown, the apparatus 700 may include the communication manager 140.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 140 and/or the reception component 702 may monitor a control channel configured within a RedCap-specific initial downlink BWP, wherein the UE is a RedCap UE operating in idle mode or inactive mode. The reception component 702 may receive at least one communication via the control channel. In some aspects, the communication manager 140 may include one or more antennas, a modem, a modulator, a transmit MIMO processor, a transmit processor, a controller/processor, a memory, or a combination thereof, of the UE described in connection with FIG. 2. In some aspects, the communication manager 140 may include the reception component 702 and/or the transmission component 704.

The reception component 702 may receive an SSB corresponding to the RedCap-specific initial downlink BWP. The communication manager 140 and/or the reception component 702 may switch to a non-RedCap-Specific initial downlink BWP. The communication manager 140 and/or the reception component 702 may monitor a BCCH corresponding to the non-RedCap-Specific initial downlink BWP, wherein the BCCH corresponds to a bandwidth that is less than or equal to a maximum bandwidth capability of the UE. The reception component 702 may receive system information via the BCCH. The reception component 702 may receive, via the BCCH, at least one of an MIB or an SIB.

The reception component 702 may receive a RedCap-specific short message that indicates a RedCap-specific SI update. The transmission component 704 may transmit, via a RACH procedure corresponding to the RedCap-specific initial downlink BWP, a request for ODSI. The communication manager 140, the reception component 702, and/or the transmission component 704 may perform, via the RedCap-specific initial downlink BWP, an initial access procedure to enter an RRC connected state.

The reception component 702 may receive a UE-specific signal corresponding to a PDSCH associated with the UE, wherein the UE-specific signal includes an updated SIB. The reception component 702 may receive an SIB corresponding to a non-RedCap-Specific initial downlink BWP, wherein the SIB indicates a mode that the UE is to use to obtain SI. The reception component 702 may receive an SIB corresponding to the RedCap-specific initial downlink BWP, wherein the SIB is associated with one or more RedCap-specific transmission parameters.

The reception component 702 may receive at least one SSB corresponding to the RedCap-specific initial downlink BWP. The communication manager 140 and/or the reception component 702 may obtain one or more RRM measurements based at least in part on the at least one SSB.

The communication manager 140, the reception component 702, and/or the transmission component 704 may switch to a non-RedCap-Specific initial downlink BWPc. The reception component 702 may receive at least one of a cell barring indication or a UAC indication via the non-RedCap-Specific initial downlink BWP. The communication manager 140, the reception component 702, and/or the transmission component 704 may switch from a non-RedCap-Specific initial downlink BWP to the RedCap-specific initial downlink BWP. The communication manager 140, the reception component 702, and/or the transmission component 704 may perform a RACH procedure corresponding to the RedCap-specific initial downlink BWP.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit a first communication on a first control channel configured within a non-RedCap-Specific initial downlink BWP. The transmission component 804 may transmit a second communication on a second control channel configured within a RedCap-specific initial downlink BWP.

The communication manager 150 may determine that a change in SI is not applicable to any RedCap UE. The transmission component 804 may transmit an SIB on the first control channel, wherein the SIB indicates the change in the SI. The transmission component 804 may refrain from transmitting an SIB on the second control channel based at least in part on determining that the change in the SI is not applicable to any RedCap UE. In some aspects, the communication manager 150 may include one or more antennas, a modem, a modulator, a transmit MIMO processor, a transmit processor, a controller/processor, a memory, or a combination thereof, of the base station described in connection with FIG. 2. In some aspects, the communication manager 150 may include the reception component 802 and/or the transmission component 804.

The reception component 802 may receive, via the non-RedCap-Specific initial downlink BWP, a request for ODSI from a UE. The transmission component 804 may transmit, via the non-RedCap-Specific initial downlink BWP, an SIB that indicates the ODSI. The transmission component 804 may refrain from transmitting an SIB indicating the ODSI via the RedCap-specific initial downlink BWP based at least in part on not receiving a request for the ODSI via the RedCap-specific initial downlink BWP.

The transmission component 804 may transmit a RedCap-specific short message that indicates a RedCap-specific SI update. The reception component 802 may receive, via a RACH procedure corresponding to the RedCap-specific initial downlink BWP, a request for ODSI from a RedCap UE. The transmission component 804 may transmit, via the RedCap-specific initial downlink BWP, an SIB that indicates the ODSI. The transmission component 804 may refrain from transmitting an SIB indicating the ODSI via the non-RedCap-Specific initial downlink BWP based at least in part on not receiving a request for the ODSI from a non-RedCap UE.

The communication manager 150, the reception component 802, and/or the transmission component 804 may perform, via the RedCap-specific initial downlink BWP, an initial access procedure to connect to a UE. The transmission component 804 may transmit a UE-specific signal corresponding to a PDSCH associated with the UE, wherein the UE-specific signal includes an updated SIB. The transmission component 804 may transmit an SIB corresponding to a non-RedCap-Specific initial downlink BWP, wherein the non-RedCap-Specific initial downlink BWP is not RedCap-specific, wherein the SIB indicates a mode that a user equipment is to use to obtain SI.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: monitoring a control channel configured within a reduced capability (RedCap)-specific initial downlink bandwidth part (BWP), wherein the UE is a RedCap UE operating in idle mode or inactive mode; and receiving at least one communication via the control channel.

Aspect 2: The method of Aspect 1, wherein the control channel comprises a paging control channel (PCCH).

Aspect 3: The method of either of Aspects 1 or 2, wherein monitoring the control channel comprises monitoring a common search space configured within the RedCap-specific initial downlink BWP.

Aspect 4: The method of any of Aspects 1-3, further comprising receiving synchronization signal block corresponding to the RedCap-specific initial downlink BWP.

Aspect 5: The method of any of Aspects 1-4, further comprising: switching to a non-RedCap-specific initial downlink BWP; and monitoring a broadcast control channel (BCCH) corresponding to the non-RedCap-specific initial downlink BWP, wherein the BCCH corresponds to a bandwidth that is less than or equal to a maximum bandwidth capability of the UE.

Aspect 6: The method of Aspect 5, further comprising receiving system information via the BCCH.

Aspect 7: The method of any of Aspects 1-6, wherein the control channel comprises a broadcast control channel (BCCH) corresponding to the RedCap-specific initial downlink BWP.

Aspect 8: The method of Aspect 7, further comprising receiving, via the BCCH, a system information block.

Aspect 9: The method of any of Aspects 1-8, further comprising receiving a RedCap-UE-specific short message that indicates a RedCap-specific system information update.

Aspect 10: The method of any of Aspects 1-9, further comprising transmitting, via a random access channel procedure corresponding to the RedCap-specific initial downlink BWP, a request for on-demand system information.

Aspect 11: The method of any of Aspects 1-10, further comprising: performing, via the RedCap-specific initial downlink BWP, an initial access procedure to enter a radio resource control connected state; and receiving a UE-specific signal corresponding to a physical downlink shared channel associated with the UE, wherein the UE-specific signal includes an updated system information block.

Aspect 12: The method of any of Aspects 1-11, further comprising receiving a system information block (SIB) corresponding to a non-RedCap-specific initial downlink BWP, wherein the SIB indicates a mode that the UE is to use to obtain system information.

Aspect 13: The method of any of Aspects 1-12, further comprising receiving a system information block (SIB) corresponding to the RedCap-specific initial downlink BWP, wherein the SIB is associated with one or more RedCap-specific transmission parameters.

Aspect 14: The method of any of Aspects 1-13, further comprising: receiving at least one synchronization signal block (SSB) corresponding to the RedCap-specific initial downlink BWP; and obtaining one or more radio resource management measurements based at least in part on the at least one SSB.

Aspect 15: The method of any of Aspects 1-14, further comprising: switching to a non-RedCap-specific initial downlink BWP; and receiving at least one of a cell barring indication or a unified access control indication via the non-RedCap-specific initial downlink BWP.

Aspect 16: The method of any of Aspects 1-15, wherein monitoring the control channel comprises monitoring a random access search space configured within the RedCap-specific initial downlink BWP.

Aspect 17: The method of Aspect 16, wherein the RedCap-specific initial downlink BWP contains only one search space, the one search space comprising the random access search space.

Aspect 18: The method of either of Aspects 16 or 17, further comprising: switching from a non-RedCap-specific initial downlink BWP to the RedCap-specific initial downlink BWP; and performing a random access channel (RACH) procedure corresponding to the RedCap-specific initial downlink BWP.

Aspect 19: The method of any of Aspects 1-18, wherein the RedCap-specific initial downlink BWP shares a common search space with a non-RedCap-specific initial downlink BWP.

Aspect 20: The method of any of Aspects 1-19, wherein the RedCap-specific initial downlink BWP shares asynchronization signal block with a non-RedCap-specific initial downlink BWP.

Aspect 21: The method of any of Aspects 1-20, wherein the RedCap-specific initial downlink BWP shares a physical random access channel with a non-RedCap-specific initial downlink BWP.

Aspect 22: A method of wireless communication performed by a network node, comprising: transmitting a first communication on a first control channel configured within a non-RedCap-specific initial downlink bandwidth part (BWP); and transmitting a second communication on a second control channel configured within a reduced capability (RedCap)-specific initial downlink BWP.

Aspect 23: The method of Aspect 22, wherein the second control channel comprises a paging control channel (PCCH).

Aspect 24: The method of either of Aspects 22 or 23, wherein the second control channel includes a common search space.

Aspect 25: The method of any of Aspects 22-24, wherein the second communication comprises a synchronization signal block.

Aspect 26: The method of any of Aspects 22-25, wherein the second communication comprises a synchronization signal block.

Aspect 27: The method of any of Aspects 22-26, wherein the first control channel comprises a broadcast control channel (BCCH), wherein the BCCH corresponds to a bandwidth that is less than or equal to a maximum bandwidth capability of a RedCap user equipment (UE).

Aspect 28: The method of Aspect 27, wherein the first communication comprises system information.

Aspect 29: The method of any of Aspects 22-28, wherein the first control channel comprises a first instance of a broadcast control channel (BCCH), and wherein the second control channel comprises a second instance of the BCCH.

Aspect 30: The method of Aspect 29, wherein the first communication comprises a first instance of a system information block (SIB), and wherein the second communication comprises a second instance of the SIB.

Aspect 31: The method of any of Aspects 22-30, wherein the first control channel comprises a first broadcast control channel (BCCH), and wherein the second control channel comprises a second BCCH that is different than the first BCCH.

Aspect 32: The method of Aspect 31, further comprising: determining that a change in system information is not applicable to any RedCap user equipment (UE); transmitting a system information block (SIB) on the first control channel, wherein the SIB indicates the change in the system information; and refraining from transmitting an SIB on the second control channel based at least in part on determining that the change in the system information is not applicable to any RedCap UE.

Aspect 33: The method of either of Aspects 31 or 32, further comprising: receiving, via the non-RedCap-specific initial downlink BWP, a request for on-demand system information (ODSI) from a user equipment (UE); transmitting, via the non-RedCap-specific initial downlink BWP, a system information block (SIB) that indicates the ODSI; and refraining from transmitting an SIB indicating the ODSI via the RedCap-specific initial downlink BWP based at least in part on not receiving a request for the ODSI from a RedCap UE.

Aspect 34: The method of any of Aspects 22-33, further comprising transmitting a RedCap-specific short message that indicates a RedCap-specific system information update.

Aspect 35: The method of any of Aspects 22-34, further comprising: receiving, via a random access channel procedure corresponding to the RedCap-specific initial downlink BWP, a request for on-demand system information (ODSI) from a RedCap user equipment; transmitting, via the RedCap-specific initial downlink BWP, a system information block (SIB) that indicates the ODSI; and refraining from transmitting an SIB indicating the ODSI via the default initial downlink BWP based at least in part on not receiving a request for the ODSI from a non-RedCap UE.

Aspect 36: The method of any of Aspects 22-35, further comprising: performing, via the RedCap-specific initial downlink BWP, an initial access procedure to connect to a user equipment (UE); and transmitting a UE-specific signal corresponding to a physical downlink shared channel associated with the UE, wherein the UE-specific signal includes an updated system information block.

Aspect 37: The method of any of Aspects 22-36, further comprising transmitting a system information block (SIB) corresponding to the non-RedCap-specific initial downlink BWP, wherein the SIB indicates a mode that a user equipment is to use to obtain system information.

Aspect 38: The method of any of Aspects 22-37, wherein the second communication comprises a system information block (SIB) associated with one or more RedCap-specific transmission parameters.

Aspect 39: The method of any of Aspects 22-38, wherein transmitting the second communication comprises transmitting the second communication to a RedCap user equipment (UE), and wherein transmitting the first communication comprises transmitting the first communication to the RedCap UE after the RedCap UE has switched to the non-RedCap-specific initial downlink BWP, wherein the first communication comprises at least one of a cell barring indication or a unified access control indication.

Aspect 40: The method of any of Aspects 22-39, wherein the second control channel comprises a random access search space.

Aspect 41: The method of Aspect 40, wherein the RedCap-specific initial downlink BWP contains only one search space, the one search space comprising the random access search space.

Aspect 42: The method of any of Aspects 22-41, wherein the RedCap-specific initial downlink BWP shares a common search space with the non-RedCap-specific initial downlink BWP.

Aspect 43: The method of any of Aspects 22-42, wherein the RedCap-specific initial downlink BWP shares a synchronization signal block with the non-RedCap-specific initial downlink BWP.

Aspect 44: The method of any of Aspects 22-43, wherein the RedCap-specific initial downlink BWP shares a physical random access channel with the non-RedCap-specific initial downlink BWP.

Aspect 45: An apparatus for wireless communication at a device, comprising a processor; memory coupled with the processor; and instructions stored in the memory and executable by the processor to cause the apparatus to perform the method of one or more of Aspects 1-21.

Aspect 46: A device for wireless communication, comprising a memory and one or more processors coupled to the memory, the one or more processors configured to perform the method of one or more of Aspects 1-21.

Aspect 47: An apparatus for wireless communication, comprising at least one means for performing the method of one or more of Aspects 1-21.

Aspect 48: A non-transitory computer-readable medium storing code for wireless communication, the code comprising instructions executable by a processor to perform the method of one or more of Aspects 1-21.

Aspect 49: A non-transitory computer-readable medium storing a set of instructions for wireless communication, the set of instructions comprising one or more instructions that, when executed by one or more processors of a device, cause the device to perform the method of one or more of Aspects 1-21.

Aspect 50: An apparatus for wireless communication at a device, comprising a processor; memory coupled with the processor; and instructions stored in the memory and executable by the processor to cause the apparatus to perform the method of one or more of Aspects 22-44.

Aspect 51: A device for wireless communication, comprising a memory and one or more processors coupled to the memory, the one or more processors configured to perform the method of one or more of Aspects 22-44.

Aspect 52: An apparatus for wireless communication, comprising at least one means for performing the method of one or more of Aspects 22-44.

Aspect 53: A non-transitory computer-readable medium storing code for wireless communication, the code comprising instructions executable by a processor to perform the method of one or more of Aspects 22-44.

Aspect 54: A non-transitory computer-readable medium storing a set of instructions for wireless communication, the set of instructions comprising one or more instructions that, when executed by one or more processors of a device, cause the device to perform the method of one or more of Aspects 22-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
monitoring a control channel configured within a reduced capability (RedCap)-specific initial downlink bandwidth part (BWP), wherein the UE is a RedCap UE operating in idle mode or inactive mode; and
receiving at least one communication via the control channel.

2. The method of claim 1, wherein the control channel comprises a paging control channel (PCCH).

3. The method of claim 1, wherein monitoring the control channel comprises monitoring a common search space configured within the RedCap-specific initial downlink BWP.

4. The method of claim 1, further comprising receiving a synchronization signal block corresponding to the RedCap-specific initial downlink BWP.

5. The method of claim 1, further comprising:
switching to a non-RedCap-Specific initial downlink BWP; and
monitoring a broadcast control channel (BCCH) corresponding to the non-RedCap-Specific initial downlink BWP, wherein the BCCH corresponds to a bandwidth that is less than or equal to a maximum bandwidth capability of the UE.

6. The method of claim 5, further comprising receiving system information via the BCCH.

7. The method of claim 1, wherein the control channel comprises a broadcast control channel (BCCH) configured within the RedCap-specific initial downlink BWP.

8. The method of claim 7, further comprising receiving, via the BCCH, a system information block.

9. The method of claim 1, further comprising receiving a RedCap-specific short message that indicates a RedCap-specific system information update.

10. The method of claim 1, further comprising transmitting, via a random access channel procedure corresponding to the RedCap-specific initial downlink BWP, a request for on-demand system information.

11. The method of claim 1, further comprising:
performing, via the RedCap-specific initial downlink BWP, an initial access procedure to enter a radio resource control connected state; and
receiving a UE-specific signal corresponding to a physical downlink shared channel associated with the UE, wherein the UE-specific signal includes an updated system information block.

12. The method of claim 1, further comprising receiving a system information block (SIB) corresponding to a non-RedCap-Specific initial downlink BWP, wherein the SIB indicates a mode that the UE is to use to obtain system information.

13. The method of claim 1, further comprising receiving a system information block (SIB) corresponding to the RedCap-specific initial downlink BWP, wherein the SIB is associated with one or more RedCap-specific transmission parameters.

14. The method of claim 1, further comprising:
receiving at least one synchronization signal block (SSB) corresponding to the RedCap-specific initial downlink BWP; and
obtaining one or more radio resource management measurements based at least in part on the at least one SSB.

15. The method of claim 1, further comprising:
switching to a non-RedCap-Specific initial downlink BWP; and
receiving at least one of a cell barring indication or a unified access control indication via the non-RedCap-Specific initial downlink BWP.

16. The method of claim 1, wherein monitoring the control channel comprises monitoring a random access search space configured within the RedCap-specific initial downlink BWP.

17. The method of claim 16, wherein the RedCap-specific initial downlink BWP contains only one search space, the one search space comprising the random access search space.

18. The method of claim 16, further comprising:
switching from a non-RedCap-Specific initial downlink BWP to the RedCap-specific initial downlink BWP; and
performing a random access channel (RACH) procedure corresponding to the RedCap-specific initial downlink BWP.

19. The method of claim 1, wherein the RedCap-specific initial downlink BWP shares at least one of a common search space, a synchronization signal block, or a physical random access channel with a non-RedCap-Specific initial downlink BWP.

20. A method of wireless communication performed by a network node, comprising:
transmitting a first communication on a first control channel configured within a non-RedCap-Specific initial downlink bandwidth part (BWP); and
transmitting a second communication on a second control channel configured within a reduced capability (RedCap)-specific initial downlink BWP.

21. The method of claim 20, wherein the second control channel comprises at least one of a paging control channel (PCCH) or a common search space.

22. The method of claim 20, wherein the first control channel comprises a broadcast control channel (BCCH), wherein the BCCH corresponds to a bandwidth that is less than or equal to a maximum bandwidth capability of a RedCap user equipment (UE).

23. The method of claim 20, wherein the first control channel comprises a first instance of a broadcast control channel (BCCH), and wherein the second control channel comprises a second instance of the BCCH, wherein the first communication comprises a first instance of at least one of a master information block (MIB) or a system information block (SIB), and wherein the second communication comprises a second instance of the at least one of the MIB or the SIB.

24. The method of claim 20, wherein the second communication comprises a system information block (SIB) associated with one or more RedCap-specific transmission parameters.

25. The method of claim 20, wherein the RedCap-specific initial downlink BWP contains only one search space, the one search space comprising a random access search space.

26. The method of claim 20, wherein the RedCap-specific initial downlink BWP shares at least one of a common search space, a synchronization signal block, or a physical random access channel with a non-RedCap-Specific initial downlink BWP.

27. A user equipment (UE) for wireless communication, comprising:
a memory; and
one or more processors, coupled to the memory, configured to:
monitor a control channel configured within a reduced capability (RedCap)-specific initial downlink bandwidth part (BWP), wherein the UE is a RedCap UE operating in idle mode or inactive mode; and
receive at least one communication via the control channel.

28. The UE of claim 27, wherein the control channel comprises at least one of a paging control channel (PCCH) or a common search space.

29. A network node for wireless communication, comprising:
a memory; and
one or more processors, coupled to the memory, configured to:
transmit a first communication on a first control channel configured within a non-RedCap-Specific initial downlink bandwidth part (BWP); and
transmit a second communication on a second control channel that corresponds to a reduced capability (RedCap)-specific initial downlink BWP.

30. The network node of claim 29, wherein the second control channel comprises at least one of a paging control channel (PCCH) or a common search space.
